(19) United States
(12) Patent Application Publication
(10) Pub. No.: US 2003/0132074 A1
(43) Pub. Date: Jul. 17, 2003

(54) Adjustable suspension device for vehicles

(76) Inventor: Lorin Robbins, Tochigi (JP)

Correspondence Address: OPPENHEIMER WOLFF & DONNELLY LLP, 840 NEWPORT CENTER DRIVE, SUITE 700, NEWPORT BEACH, CA, 92660, US

(21) Appl. No.: 10/262,324

(22) Filed: Sep. 30, 2002

Related U.S. Application Data
(63) Continuation-in-part of application No. 09/566,501, filed on May 8, 2000, now abandoned.
(63) Continuation-in-part of application No. 10/142,598, filed on May 8, 2002, now abandoned.

(51) Int. Cl. F16F 9/34

(52) U.S. Cl. 188/322.15

(57) ABSTRACT

The present invention discloses an adjustable suspension device capable of attaching to a variety of vehicles with little or no modification to the existing suspension system. More specifically, the adjustable suspension device of the present invention comprises a suspension cylinder attached to an elongated body, a suspension chamber formed in the suspension cylinder, a piston assembly movable within the suspension chamber, an dampening device in communication with the piston assembly, and a fluid coupler attached to the suspension cylinder and in communication with the suspension chamber. The fluid coupler may be in communication with a fluid source through fluid conduit. In another embodiment of the present invention, the present invention discloses a bearing device for attaching a suspension member to a vehicle and comprises a plate having an aperture formed thereon, a receiver having a curved face coupled to the plate, and a bearing having a curved member sized to engage the curved face of the receiver in movable relation.

### CROSS REFERENCE TO RELATED APPLICATIONS

This application is a Continuation-in-Part of U.S. patent application Ser. No. 09/566,501, filed May 8, 2000, and U.S. patent application Ser. No. 10/142,598, filed May 8, 2002, both naming Lorin Robbins as inventor, and whose entire contents are hereby incorporated by reference in their entirety as if fully set forth herein.

### BACKGROUND OF THE INVENTION

Generally, most vehicles employ a suspension system to compensate for and mitigate damage caused by discontinuities in the surface being traversed. For example, a modern automobile typically employs a suspension system which may include a series of suspension springs, shock absorbers, and strut assemblies positioned between the vehicle's axles and the vehicle chassis to cushion shock impinged upon the axles by the wheels striking objects, depressions, or discontinuities in the road. Typically, suspension springs are comprised of steel or other material formed into a coiled spring or leaf spring configuration. Shock absorbers generally comprise a piston positioned within a hydraulic or pneumatic compression chamber. Strut assemblies, similar to shock absorbers in design, comprise a piston positioned within a pneumatic compression chamber and/or a coil spring. Generally, modern suspension designs, for example multi-link suspension systems or torsion bar suspension systems, incorporate a combination of springs, shock absorbers, and struts.

Suspension systems, in additional to improving ride quality and comfort, may be incorporated as an element of the vehicle's steering system. For example, strut systems are utilized in the steering system, thereby providing a link between the steering and suspension systems. Commonly, an individual strut is functionally attached to a tie rod or other steering component associated with an individual wheel. As such, struts frequently include a bearing system located therein or thereon to permit a degree of axial rotational to accommodate the steering system requirements. While these suspension systems have improved ride quantity somewhat, several shortcomings have been identified. For example, minor adjustments to the suspension system often tend to be time-intensive adjustments and often require specialized tools and training.

Recently, pneumatic springs, commonly known as air springs, have been incorporated into some suspension systems to offer greater ride quality. Generally, these air spring systems are used on large commercial trucks in a tractor-semitrailer configuration to transport goods on interstate highways. Commonly, these air springs comprise a flexible rubber chamber or bellow in communication with a compressed gas source, and one or more pistons positioned with the flexible rubber bellow to receive and engage mounting plates attached to the vehicle. These air spring systems offer many advantages over conventional suspension systems in that the supportive pressure applied by the air spring may be easily varied.

One problem associated with present air spring systems arises when affixing the air spring system to conventional suspension designs. Generally, a vehicle having a conventional suspension design, for example, a conventional multi-link suspension system, would require substantial modification to incorporate an air spring suspension system. In addition, the steering system of the vehicle may require similar modification to remain functional. For the foregoing reasons, air suspension systems have yet to receive widespread usage in many vehicles.

Thus, there is a need for an adjustable suspension device capable of easily attaching to and operating with conventional vehicle suspension designs and components. Ideally, the envisioned adjustable suspension device would be capable of attaching to the vehicle's suspension system with little or no modification.

### BRIEF SUMMARY OF THE INVENTION

The present invention provides an adjustable suspension device for a vehicle. More specifically, the present invention discloses an adjustable suspension device capable of being attached to a vehicle with little or no modification to the existing vehicle. Those skilled in the art will appreciate that the present invention permits the user to easily alter the suspension characteristics of a stationary or moving vehicle.

In one embodiment, the adjustable suspension device of the present invention comprises a suspension cylinder attached to an elongated body, a suspension chamber formed in the suspension cylinder, a piston assembly movable within the suspension chamber, a dampening device in communication with the piston assembly, and a fluid coupler attached to the suspension cylinder and in communication with the suspension chamber. The fluid coupler may be in communication with a fluid source through fluid conduit.

In another embodiment, the present invention discloses a bearing device for attaching a suspension member to a vehicle and comprises a plate having an aperture formed thereon, a receiver having a curved face coupled to the plate, and a bearing having a curved member sized to engage the curved face of the receiver in movable relation.

In another embodiment, the present invention is directed to an adjustable suspension system for a vehicle and includes an adjustable suspension device comprising a suspension cylinder attached to an elongated body wherein the suspension cylinder defining a suspension chamber and includes a piston assembly movable within the suspension chamber, a dampening device in communication with the piston assembly, and a fluid coupler attached to the suspension cylinder and in communication with the suspension chamber. A bearing device configured to couple the adjustable suspension device to a vehicle is included and comprises a plate having an aperture formed thereon, a receiver having a curved face coupled to the plate, and a bearing having a curved member sized to engage the curved face of the receiver in movable relation. Thereafter, the fluid coupler is coupled to or otherwise in communication with a fluid source through fluid conduit.

Other objects and further features of the present invention will become apparent from the following detailed description when read in conjunction with the attached drawings.

### BRIEF DESCRIPTION OF THE DRAWINGS

The apparatus of the present invention will be explained in more detail by way of the accompanying drawings, wherein:

FIG. 1 shows a perspective view of the adjustable suspension device of the present invention;

FIG. 2 shows a sectional view of the adjustable suspension device of the present invention;

FIG. 3 shows a cross-sectional view of the adjustable suspension device of the present invention;

FIG. 4 shows a perspective view of the fluid coupler positioned on an adjustable suspension device of the present invention;

FIG. 5 shows a perspective view of the bearing plate of the bearing device of the present invention;

FIG. 6 shows an exploded view of the bearing device of the present invention;

FIG. 7 shows a cross-sectional view of the bearing device of the present invention positioned on a fluid coupler;

FIG. 8 shows a perspective view of the bearing device of the present invention positioned on a suspension device; and

FIG. 9 shows a schematic of a suspension circuit incorporating the adjustable suspension device of the present invention.

### DETAILED DESCRIPTION OF THE INVENTION

Disclosed herein is a detailed description of various illustrated embodiments of the present invention. This description is not to be taken in a limiting sense, but is made merely for the purpose of illustrating the general principles of the invention.

The present invention is directed to an adjustable suspension device for vehicles. More particularly, the adjustable suspension device of the present invention is capable of attaching to a vehicle while requiring little or no modification to the existing suspension system. In addition, the present invention permits the operator of the vehicle to easily alter the suspension characteristics of the vehicle, thereby enabling the operator to tailor the ride characteristics of the vehicle as desired. As those skilled in the art will appreciate, the present invention may be manufactured in a variety of sizes and may be adapted for use with a variety of vehicles.

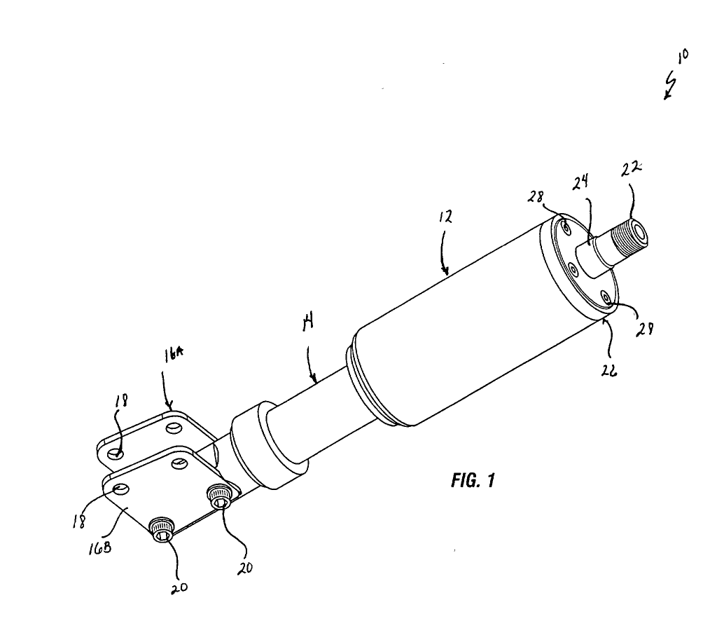

FIG. 1 shows an embodiment of the adjustable suspension device of the present invention. As shown in FIG. 1, the adjustable suspension device 10 comprises a suspension cylinder 12 attached to or otherwise in communication with an elongated body 14. The elongated body 14 may include at least one coupling flange or member attached thereto. In the illustrated embodiment a first coupling flange 16A and a second coupling flange 16B are attached to the elongated body 14. Those skilled in the art will appreciate that the coupling flange of the present invention may be manufactured in a variety of configurations, thereby permitting the adjustable suspension device 10 of the present invention to be installed on a variety of vehicles. The coupling flanges 16A, 16B may include one or more coupling ports 18 formed thereon. The coupling ports 18 may be capable of receiving various flange couplers 20 therein. The flange couplers 20 may also be used to couple the first and second coupling flanges 16A, 16B to the elongated body 14. A fluid coupler 22 may be positioned with a coupler receiver 24 located on the cylinder cover 26 of the suspension cylinder 12. In the illustrated embodiment one or more cylinder cover attachment members 28 are used to couple the cylinder cover 26 to the suspension cylinder 12, although those skilled in the art will appreciate that the cylinder cover 26 may be attached to the suspension cylinder 12 in a plurality of ways. For example, the cylinder cover 26 may couple to the suspension cylinder in slip-fit relation, screw-fit relation, or may be integral to the suspension cylinder 12. Those skilled in the art will appreciate that the adjustable suspension device 10 or the various components thereof may be manufactured from a variety or combination of materials including, without limitation, brass, steel, titanium, aluminum, metallic alloys, plastics, elastomers, silicones, and composite materials.

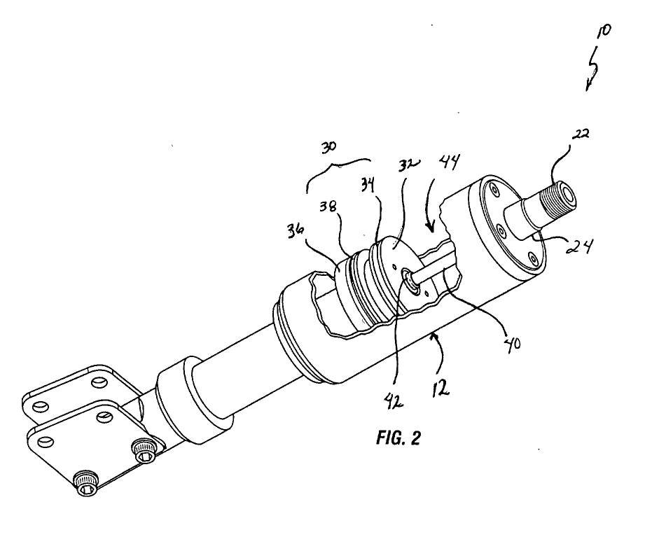

FIG. 2 shows the internal components of the adjustable suspension device 10 of the present invention. As shown, a piston assembly 30 is positioned within the suspension cylinder 12. The piston assembly 30 comprises a first piston member 32 having a first piston seal 34 attached thereto and a second piston member 36 having a second piston seal 38 attached thereto. A dampener extension 40, extending from a dampener passage 42 formed in the piston assembly, traverses the suspension chamber 44.

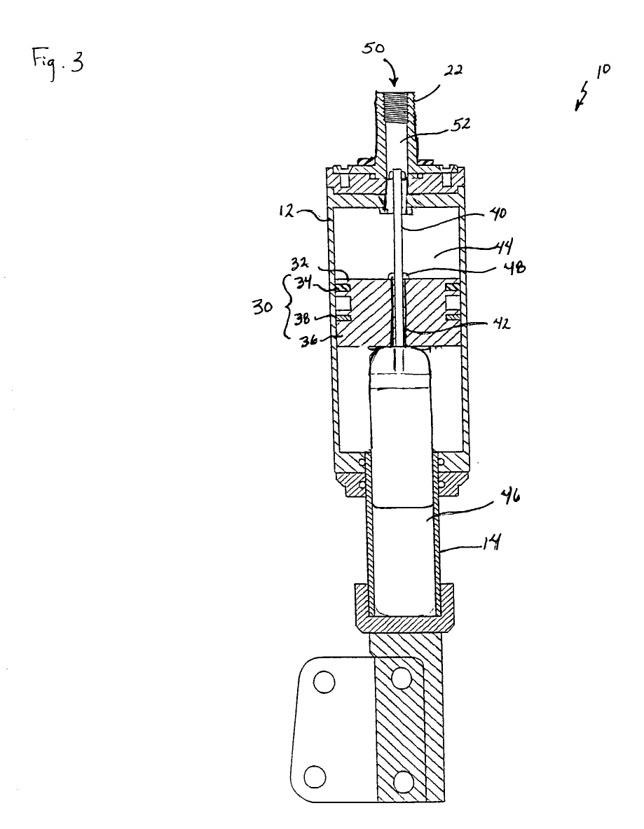

FIG. 3 shows a cross-sectional view of the adjustable suspension device 10 of the present invention. As shown, a dampening device 46 may be positioned within the elongated body 14. The dampener extension 40 is shown extending through the dampener passage 42 formed in the piston assembly 30. In the illustrated embodiment, the piston assembly 30 is comprised of a first piston member 32 integral with the second piston member 36, although those skilled in the art will appreciate that the piston assembly 30 may be comprised of individual components. The first piston member 32 may include a groove positioned thereon sized to receive the first piston seal 34 therein. Similarly, the second piston member 36 may include a groove positioned thereon sized to receive the second piston seal 38 therein. A dampener seal 45 may be positioned within or proximate to the dampener passage 42 formed in the piston assembly 30. The dampener seal 48 isolates the suspension chamber 44 from the dampener 46. During use, the dampener 46 limits the oscillation of the piston assembly within the suspension chamber 44. In the illustrated embodiment, the dampener 46 comprises a conventional vehicle strut although those skilled in the art will appreciate a variety of dampening devices may be used with the present invention. Alternate dampening devices include, for example, elastomer pads, elastomer members, coiled springs, pneumatic cartridges, hydraulic cartridges, fluid cartridges, air bladders, air bags, struts, cartridges struts, and shock absorbers.

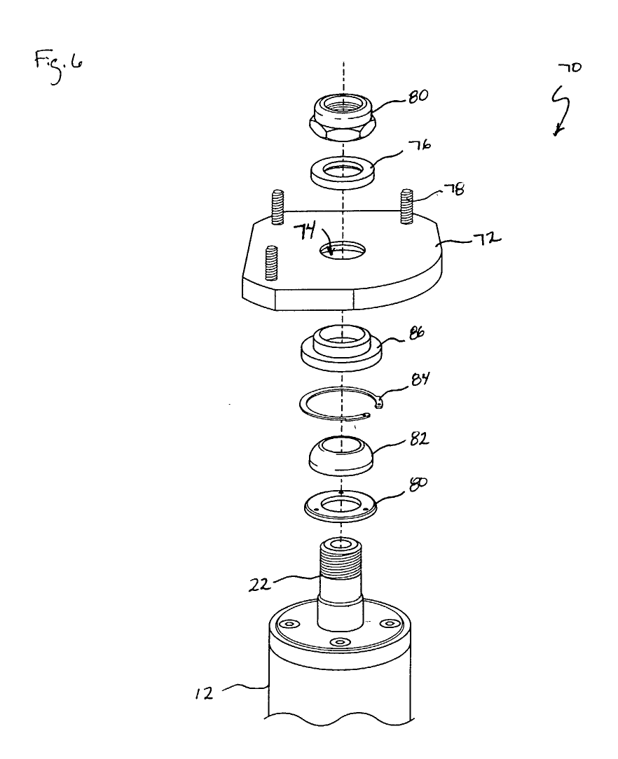

Referring to FIGS. 3-5, the fluid coupler 22 includes a fluid orifice 50 attached to a fluid passage 52 formed therein. The fluid passage 52 is in fluid communication with suspension chamber 44 formed in the suspension cylinder 12. During use, fluid received from a fluid source (not shown) flows into the suspension chamber 44 through the fluid coupler 22. The fluid coupler 22 may be sized to receive an attachment device thereon. An exemplary bearing device 70, shown in FIG. 5, enables the adjustable suspension device 10 of the present invention to be attached to a variety of vehicles with little or no modification. The bearing 70 comprises a bearing plate 72 having receiving aperture 74 formed thereon and a bearing member 76 located proximate thereto. At least one attachment device 78 may be positioned on or coupled to the bearing plate 72.

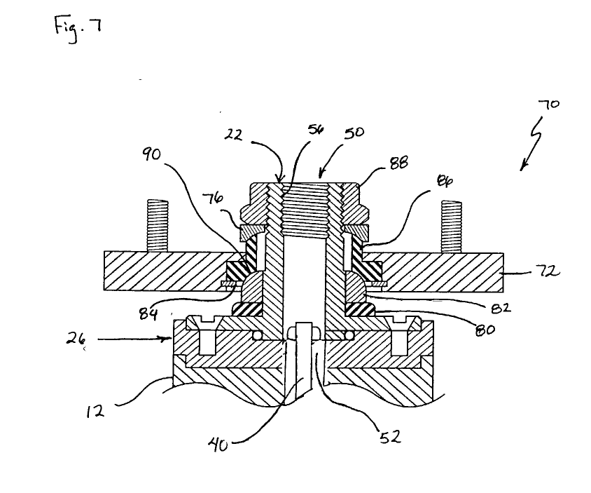

FIG. 6 shows an exploded view of the components of the bearing device 70. As shown, the bearing device 70 comprises a washer 80 and a bearing 82 which are sized to be positioned on the fluid coupler 22. A lock ring 84 is used to attach a bearing receiver 86 to the bearing plate 72. The bearing receiver 86 is sized to movably receive the bearing 82 therein and is capable of receiving the fluid coupler 22 therethrough. A lock nut 88 capable of engaging and being retained on the fluid coupler 22 is positioned proximate to the bearing washer 76 and is used to couple the bearing device 70 to the fluid coupler 22. Like the suspension cylinder 12 disclosed above, those skilled in the art will appreciate that the various components of the bearing device 70 may be manufactured from a variety or combination of materials including, without limitation, brass, steel, titanium, plastic, elastomer, silicon, and composite materials.

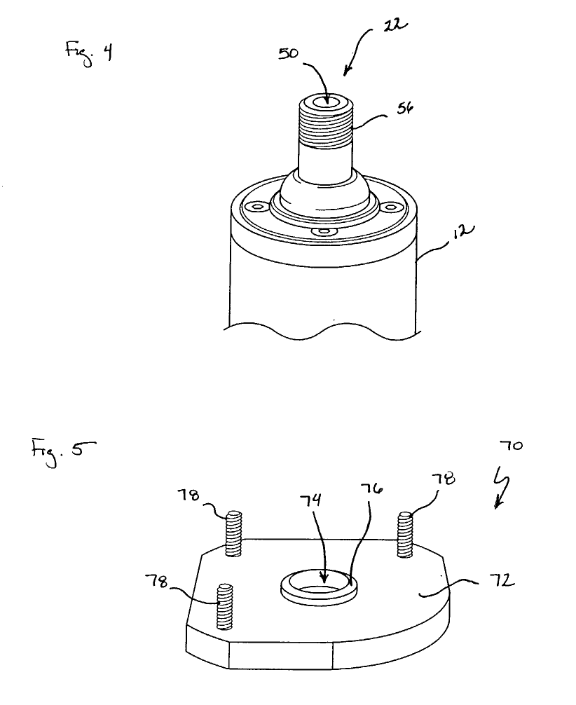

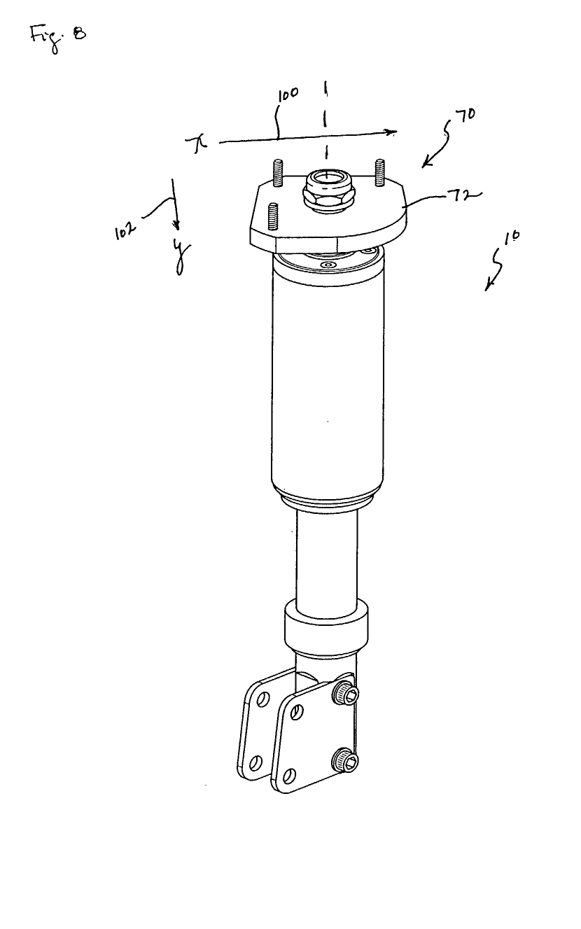

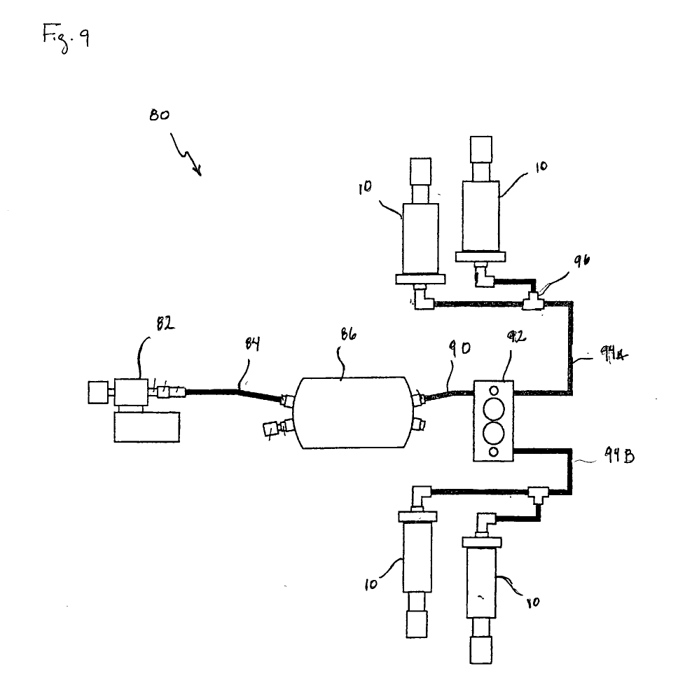

FIGS. 7-8 show various views of the bearing device 70 of the present invention. FIG. 7 shows a cross-sectional view of the bearing device 70 attached to the fluid coupler 22 of the present invention. As shown, the fluid coupler 22 is positioned within and traverses through the coupler receiving aperture 74 formed on the bearing plate 72. The washer 80 is located proximate to the cylinder cover 26 affixed to the suspension cylinder 12. The bearing receiver 86 is removably coupled to the bearing plate 72 with the lock ring 84. The bearing receiver 86 includes a curved face 90 sized to receive the bearing 82 therein. The bearing washer 76 is positioned between the lock nut 88 and the bearing receiver 86. The lock nut 88 couples the various components of the bearing device 70 to the fluid coupler 22 by engaging threads 56 positioned thereon. As shown in FIG. 7, the fluid orifice 50 is in fluid communication with the fluid passage 52 which is attached to the suspension chamber 44 (see FIG. 3). The dampener extension 40 is removably anchored to the suspension cylinder 12 within the fluid passage 52. FIG. 8 shows the bearing device 70 attached to the adjustable suspension device 10 of the present invention. Those skilled in the art will appreciate that the interaction of the bearing 82 and the curved face 90 of the bearing receiver 86 (see FIG. 7) permits the free movement of the bearing plate 72 in the X direction 100 and the Y direction 102 in relation to the longitudinal axis L of the adjustable suspension device 10. When attached to the vehicle, the bearing device 70 permits the adjustable suspension device 10 to pivot in response to variations in the road surface and limit the amount of force applied to the fluid coupler 22 (see FIG. 4) in response thereto.

FIG. 9 shows a diagram of a suspension circuit 80 incorporating four adjustable suspension devices 10 of the present invention, although any number of suspension devices 10 may be utilized in the suspension circuit as desired by the user. Referring to FIG. 9, the suspension circuit 80 may include a fluid compressor or pump 82 having a first fluid supply line 84 in fluid communication therewith. Those skilled in the art will appreciate that a variety of fluid compressors may be used in the suspension circuit 80, including, for example, “Ride-Rite” air compressors manufactured by the Firestone Industrial Products Company. The fluid compressor 82 may be attached to the vehicle (not shown) and connected to a vehicle battery or power supply (not shown). The first fluid supply line 84 may be coupled to a fluid supply tank 86 attached to the vehicle (not shown). Typically, 3 to 5 gallon fluid supply tanks are used to provide a fluid reservoir, however, fluid supply tanks of various volumes may be used as desired by the user. A second fluid supply line 90 may be connected to the fluid supply tank 86 and a valve and gauge unit 92. The valve and gauge unit 92 may be used to regulate the flow of fluid between the fluid supply tank 88 and the suspension device 10, thereby permitting the user to monitor and control the suspension characteristics of the vehicle. Ideally, the valve and gauge unit 92 is positioned within the passenger compartment of the vehicle. Exemplary valve and gauge units include, for example, the “Ride-Rite” 2-way billet control panel manufactured by the Firestone Industrial Products Company. At least one suspension line may be used to connect the individual suspension units 10 to the valve and gauge unit 92. In the illustrated embodiment, suspension lines 94A, 94B connect four suspension units 10 to the valve and gauge unit 92. If desired, one or more t-connectors 96 may be positioned on the suspension lines 94A, 94B to facilitate the connection of multiple suspension units 10 to the suspension circuit 80.

Referring to FIGS. 3 and 9, the user actuates the valve and gauge unit 92 to permit the flow of fluid between the suspension device 10 and the fluid supply tank 86. As a result, the volume of fluid within the suspension chamber 44 formed in the suspension cylinder 12 may be controlled, thereby permitting the user to alter the ride characteristics of the vehicle. For example, to increase the ground clearance of the vehicle the user may actuate the valve and gauge unit 92 which opens a valve (not shown) located in the valve and gauge unit 92 and results in the fluid flowing from the fluid supply tank 86 into suspension chamber 44 formed in the cylinder 12. The piston assembly 30 may move within the cylinder 12 in response to the increasing fluid pressure within the suspension chamber thereby resulting in the suspension chamber 44 increasing in volume and, in turn, raising the vehicle. To lower the vehicle, the user may actuate another actuator located on the valve and gauge unit 92 which opens the valve (not shown) of the valve and gauge unit 92 and results in the fluid flowing from the suspension chamber 44 formed in the cylinder 12 into fluid supply tank 86 or, in the alternative, vented to the atmosphere. The piston assembly 30 may move within the cylinder 12 in response to the decreasing fluid pressure within the suspension chamber thereby resulting in the suspension chamber 44 decreasing in volume and, in turn, lowering the vehicle.

In closing, it is understood that the embodiments of the invention disclosed herein are illustrative of the principals of the invention. Other modifications may be employed which are within the scope of the present invention. Accordingly, the present invention is not limited to that precisely as shown and described in the present disclosure.

What is claimed is:

1. An adjustable suspension device for a vehicle, comprising:
a suspension cylinder attached to an elongated body, said suspension cylinder defining a suspension chamber;
a piston assembly movable within said suspension chamber;
an dampening device in communication with said piston assembly; and
a fluid coupler attached to said suspension cylinder and in communication with said suspension chamber, said fluid coupler in communication with a fluid source through fluid conduit.

2. The device of claim 1 wherein said piston assembly further comprises:
a first piston member having a first piston seal positioned thereon;
a second piston member having a second piston assembly positioned thereon; and
a dampener passage formed in the first and second piston members, said dampener passage sized to receive at least a portion of said dampening device therethrough.

3. The device of claim 1 wherein said dampening device comprises at least one device selected from the group consisting of elastomer pads, elastomer members, coiled springs, pneumatic cartridges, hydraulic cartridges, fluid cartridges, air bladders, air bags, struts, cartridges struts, and shock absorbers.

4. The device of claim 1 wherein said dampening device is positioned within at least one of suspension cylinder and said elongated body.

5. The device of claim 1 wherein said suspension cylinder is integral to said elongated body.

6. The device of claim 1 further comprising at least one coupling member capable of coupling said suspension cylinder to a vehicle.

7. The device of claim 1 wherein said suspension device is manufactured from at least one material selected from the group consisting of brass, steel, titanium, aluminum, metallic alloys, plastics, elastomers, silicones, and composite materials.

8. The device of claim 1 further comprising a bearing device attached thereto.

9. A bearing device for attaching a suspension member to a vehicle, comprising:
a plate having an aperture formed thereon;
a receiver coupled to said plate, said receiver having a curved face; and
a bearing having a curved member sized to engage said curved face of said receiver in movable relation.

10. The device of claim 9 further comprising a fastening device capable of coupling at least one of said plate, said receiver, and said bearing to said suspension device.

11. An adjustable suspension system for a vehicle, comprising:
an adjustable suspension device comprising
a suspension cylinder attached to an elongated body, said suspension cylinder defining a suspension chamber;
a piston assembly movable within said suspension chamber;
an dampening device in communication with said piston assembly;
a fluid coupler attached to said suspension cylinder and in communication with said suspension chamber, said fluid coupler in communication with a fluid source through fluid conduit; and
a bearing device configured to couple said adjustable suspension device to a vehicle and comprising:
a plate having an aperture formed thereon;
a receiver coupled to said plate, said receiver having a curved face;
a bearing having a curved member sized to engage said curved face of said receiver in movable relation.
